(19) United States
(12) Patent Application Publication
(10) Pub. No.: US 2006/0089113 A1
(43) Pub. Date: Apr. 27, 2006

(54) Radio control receiver system for multiple bands, frequencies and modulation protocol coverage

(76) Inventors: Aroosh Rizwan Elahi, Ottawa (CA); Ioannis Lambadaris, Ottawa (CA); Jorge Adalberto Perez Calles, Ottawa (CA)

Correspondence Address: ABELMAN, FRAYNE & SCHWAB, 666 THIRD AVENUE, 10TH FLOOR, NEW YORK, NY, 10017, US

(21) Appl. No.: 11/229,213

(22) Filed: Sep. 16, 2005

Related U.S. Application Data
(60) Provisional application No. 60/610,179, filed on Sep. 16, 2004.

(51) Int. Cl. H04B 1/18

(52) U.S. Cl. 455/179.1; 455/168.1; 455/188.1

(57) ABSTRACT

The present invention provides a radio receiver system for a radio controlled device with the ability to select an operating frequency for a radio controlled receiver unit using a modular programmer to be plugged into the receiver unit in order to select and program the receiver unit with an operating frequency, and then removed so that no further weight is left on the receiver unit. The radio receiver system comprises a programming unit and a receiver unit. The programming unit comprises a selector for selecting a value corresponding to a desired operating frequency for the receiver unit; and a signaler for initiating transmission of the selected value to the receiver unit for programming the receiver unit with the selected operating frequency. The receiver unit is adapted to accept a selected value from a programming unit and comprises a retriever for obtaining the selected value from the programming unit; at least one analog-to-digital converter for converting the selected value into a digital signal; a microcontroller connected to the at least one analog-to-digital converter for receiving the digital signal and for determining the desired operating frequency of the receiver unit therefrom; a voltage controlled oscillator and a phase lock loop operatively coupled to the microcontroller for generating the desired operating frequency; and an antenna for receiving radio controlled signals from a transmitting unit at the desired operating frequency.

### BACKGROUND OF THE INVENTION

1. Field of the Invention

The present invention relates to radio control receivers for radio controlled devices used in the radio control hobby industry, such as model airplanes, model vehicles, robots and the like. More particularly, the present invention relates to a radio control receiver system for radio controlled devices, which can operate at multiple frequency bands and that can detect different encoding protocols used in the radio control hobby industry.

2. Description of the Prior Art

In the radio control hobby industry, radio controlled devices, such as model airplanes, model vehicles, model ships, robots, and the like, are usually operated in crowded environments, such as at shows, where there are several radio controlled devices being used at the same time. To avoid conflicts with other radio controlled devices, each device is assigned a unique operating frequency. In the past, selecting an operating frequency for the receiver unit of the radio controlled device involved replacing a crystal defining the operating frequency of the receiver unit located within the radio controlled device. A user was effectively required to bring a bag of crystals and plug them into the radio receiver unit to identify the specific operating frequency of the receiver unit in order to prevent any conflicts with other users. The problem with exchanging the crystal of the receiver unit is that the crystals are somewhat fragile and fairly expensive to purchase, costing approximately US$10 each. Furthermore, the process of inserting the crystal into the receiver unit and vibration of the device during operating often leads to intermittent connections in the receiver unit, resulting in degraded performance of the receiver unit.

To overcome the aforementioned problems, numerous radio controlled receivers have been developed which are capable of operating at many different frequencies within a frequency band. For example, radio controlled receivers for radio controlled devices which utilize an auto-search method to select an operating frequency for the receiver unit have been developed. However, the use of an auto search method has an inherent problem with interference since it selects whatever channel is the strongest available at the time of selection. Thus the channel selected may also be selected by another device. In any event, such receivers and controllers are typically more complex and have disadvantages in terms of weight, reliability, and cost. In radio-controlled aircraft in particular, weight of the on-board receiver is a significant design factor.

U.S. Pat. No. 5,608,758 issued to Futaba et al. discloses a radio controlled receiver unit for radio controlled device with integrated rotary switches. However, a drawback of the Futaba et al. device is that the switches add extra weight to the device, which as indicated above, is undesirable by most users as it adversely affects the performance of the radio controlled device. Another drawback of the Futaba et al. device is that a user of the device has to power cycle the radio controlled device every time a different operating frequency is selected. Furthermore, the Futaba et al. device requires the receiver to read the rotary switch values every time power is applied. The disadvantage of reading the rotary switch values at power-up and then setting the PLL for the proper frequency operation is that it can take a few milliseconds. Any reduction in the time taken to boot up the receiver is critical and can be very desirable because if a momentary power loss happens during flight of a radio controlled aircraft, there will be extra delay to decode the switches and tune the radio receiver in which case loss of control may result. Also, if the switches become noisy or defective due to vibrations in the radio controlled device, such as a radio controlled aircraft, the receiver may be programmed with an incorrect frequency after the momentary power loss, in which case the receiver will lose contact with the transmitter. This is especially true if a boot-up happens mid-air due to low battery conditions. Another disadvantage of the Futaba et al. device is that the interface of the rotary switches requires a minimum of 4 pins on the interface device (micro-controller, micro-processor, etc.), which makes this device rather complex to manufacture.

In the radio controlled hobby industry, each type of radio controlled device operates at different frequency bands. For example, in North America, there are three licensed frequencies used to operate radio controlled devices, the 50 MHz band is reserved for amateur radio operators (HAM) for any kind of surface or air model, the 72 MHz band for model airplanes/helicopters and the 75 MHz band is reserved for surface vehicles e.g. cars, trucks, motorcycles, surface robots. In other foreign jurisdictions, the 35, 36, 40, 41, and 53 Mhz frequency bands are used for operation of radio controlled devices. Currently, there are no prior art devices in the radio controlled hobby industry which offer multi-band operation, i.e. that are capable of operating in any one of the known frequency bands, without replacing the crystal of the receiver unit.

What is therefore needed is a radio receiver for a radio controlled device used in the radio control hobby industry that reduces the number of circuitry components, resulting in a reduction in the weight and complexity of the radio receiver, thereby increasing the performance and reliability of the radio controlled device in operation. What is also needed is a radio receiver system that is simple to program with a desired operating frequency, inexpensive to manufacture, and capable of operating within each of the multiple frequency bands designated for the radio control hobby industry.

### SUMMARY OF THE INVENTION

The present invention seeks to provide a radio receiver system for a radio controlled device with the ability to select an operating frequency for a radio controlled receiver unit using a modular programmer to be plugged into the receiver unit in order to select and program the receiver unit with an operating frequency, and then removed so that no further weight is left on the receiver unit. The advantages of the present invention are that it provides a simple apparatus to select the operating frequency of the receiver unit, it is very inexpensive to manufacture, it reduces the weight of the receiver unit and increases its ruggedness. A further advantage is that the programmer unit may also be used to select certain operating modes of the receiver unit, such as failsafe modes, digital signal processing modes, and selection of peripheral control signals on specific output pins of the device.

The radio receiver unit of the present invention covers multiple bands utilized in different regions of the world, such as the 35 MHz, 36MHz, 40 MHz, 41 MHz, 50 MHz, 53 MHz, 72 MHz, and 75 MHz operating frequency bands. The radio receiver system comprises two units: a RF (radio frequency) receiver unit and a passive modular detachable programming unit that can cover multiple frequency bands and can be used to select over 90 different operational frequencies. It should be noted that by using a plurality of rotary switches, the programming unit can cover a very large number of frequencies (10ⁿ, where “n” is the number of 10 position rotary switches on the programmer of the present invention). In the preferred embodiment of the invention described herein, n=2.

In contrast to the prior art solutions, the radio receiver of the present invention provides a simple multi-protocol detection method used to detect all the known encoding protocols used in the radio control hobby industry. The present invention can detect analog positive shift pulse position modulation (PPM), analog negative shift PPM, and digital pulse code modulation (PCM) protocols. The frequency selection methodology of the present invention is more reliable than those disclosed in the prior art.

The present invention also provides an iterative optimization procedure for pre-determining the structure of a resistor network for the detachable programming unit, which provides the required minimal voltage separation in each frequency band and which utilizes most efficient resistor values, while minimizing the number of resistors in the resistor network.

According to a broad aspect, the present invention seeks to provide a multi-band radio control receiver system for a radio controlled device comprising:
a detachable programming unit for programming a radio frequency receiver unit with a desired operating frequency, the programming unit comprising:
   a selector for selecting a value corresponding to the desired operating frequency for the receiver unit; anda signaler for indicating availability of the selected value to the radio frequency receiver unit; and the radio frequency receiver unit comprising:
a retriever for obtaining the selected value from the programming unit:
at least one analog-to-digital converter for converting the selected value from the selector into a digital signal;
a microcontroller operatively coupled to the at least one analog-to-digital converter for receiving the digital signal and for determining the desired operating frequency of the receiver unit therefrom;
a voltage controlled oscillator and a phase lock loop operatively coupled to the microcontroller for generating the desired operating frequency; and
an antenna for receiving radio controlled signals from a transmitting unit at the desired operating frequency.

In another aspect, the present invention seeks to provide a programming unit for a receiver unit of a radio controlled device, comprising;
a selector for selecting a value corresponding to a desired operating frequency for the receiver unit; and
a signaler for indicating availability of the selected value to the receiver unit for programming the receiver unit with the desired operating frequency.

In still another aspect, the present invention seeks to provide a programmable receiver unit for a radio controlled device adapted to obtain a selected value from a programming unit, comprising:
a retriever for obtaining the selected value from the programming unit;
at least one analog-to-digital converter for converting the selected value into a digital signal;
a microcontroller operatively coupled to the at least one analog-to-digital converter for receiving the digital signal and for determining the desired operating frequency of the receiver unit therefrom;
a voltage controlled oscillator and a phase lock loop operatively coupled to the microcontroller for generating the desired operating frequency; and
an antenna for receiving radio controlled signals from a transmitting unit at the desired operating frequency.

In still another aspect, the present invention seeks to provide a programmable transmitter unit for a radio controlled device adapted to obtain a selected value from a programming unit, comprising:
a retriever for obtaining the selected value from the programming unit;
at least one analog-to-digital converter for converting the selected value into a digital signal;
a microcontroller operatively coupled to the at least one analog-to-digital converter for receiving the digital signal and for determining the desired operating frequency of the receiver unit therefrom;
a voltage controlled oscillator and a phase lock loop operatively coupled to the microcontroller for generating the desired operating frequency; and
an antenna for transmitting radio controlled signals to a receiver unit at the desired operating frequency.

### BRIEF DESCRIPTION OF THE DRAWINGS

The embodiments of the invention will now be described, by way of example, with reference to the accompanying drawings in which:

FIG. 1 is a block diagram of a radio receiver system of an embodiment of the invention;

FIGS. 2A, 2B and 2C are schematic designs for the detachable programming unit of the radio receiver system of FIG. 1;

FIG. 3 is a flowchart diagram illustrating a method of selective frequency injection used in the radio receiver system of FIG. 1;

FIG. 4 is a flowchart illustrating an iterative method for resistor optimization of the detachable programming unit of FIGS. 1 and 2;

FIG. 5 is a schematic design of the multi-protocol detection circuit used in the radio receiver system of FIG. 1; and

FIG. 6 is a flowchart diagram illustrating the multi-protocol detection method used in the radio receive system of FIG. 1.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

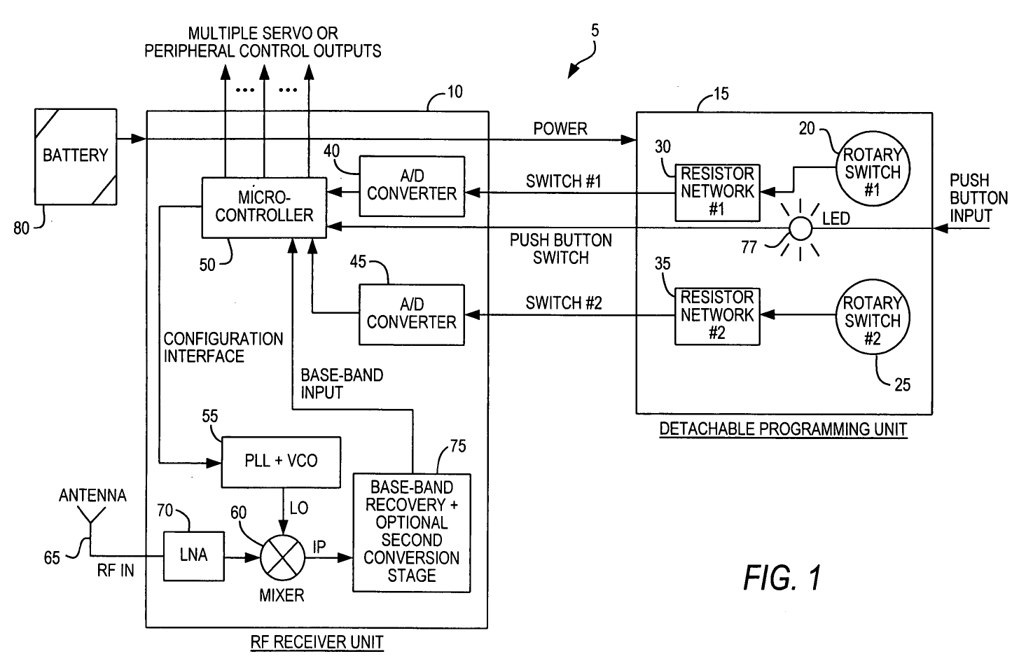

Referring to FIG. 1, a radio receiver system 5 of the present invention is shown. The radio receiver system 5 comprises two discrete units: a radio frequency (RF) receiver unit 10; and a passive detachable programming unit 15. The detachable programming unit 15 is only used whenever a user wishes to select an operating frequency for the RF receiver unit 10. The detachable programming unit 15 comprises two rotary switches 20, 25 which are binary coded decimal (BCD) encoded 10 position switches with markings from 0-9. The two rotary switches 20, 25 are used to select one of 100 unique frequencies to program the receiver unit 10. Those having ordinary skill in the relevant art will readily recognize that the programming unit 15 can be expanded to provide 10ⁿ unique frequencies, where n=total number of BCD encoded 10 position rotary switches. Moreover, those having ordinary skill in the relevant art will readily recognize that the choice of a BCD-encoding and/or of a 10 position switch is for convenience and exemplary only. Any switch having a suitable number of positions could be utilized for any of the switches and any suitable encoding scheme could be applied.

The programming unit 15 also includes two resistor networks 30, 35, each of which is connected to each of the rotary switches 20, 25 respectively. It should be noted that he resistor networks 30 and 35 are similar and that the resistor values are predetermined using an methodology described below, to provide a reasonable minimum voltage separation between each switch position so that each analog to digital converter 40, 45 of the receiver unit 10 can un-ambiguously detect the proper switch position. Any suitable resistor network known to those of ordinary skill in the relevant art could be applied.

The receiver unit 10 comprises two analog to digital converters 40, 45, each of which is operatively coupled to a microcontroller 50. The microcontroller 50 is connected to a voltage controlled oscillator (VCO) and a phase locked loop (PLL) circuit 55, which in turn is connected to a signal mixer circuit 60. The receiver unit 10 also includes an antenna 65 for receiving a radio frequency signal from the transmitter of a radio controlled device (not shown). The antenna 65 is connected to a low noise amplifier 70, which in turn is connected to the signal mixer circuit 60. The signal mixer circuit 60 is connected to a base-band recovery and optional second conversion stage circuit 75, which is connected back to the microprocessor 50. The receiver unit 10 is powered by a battery 80.

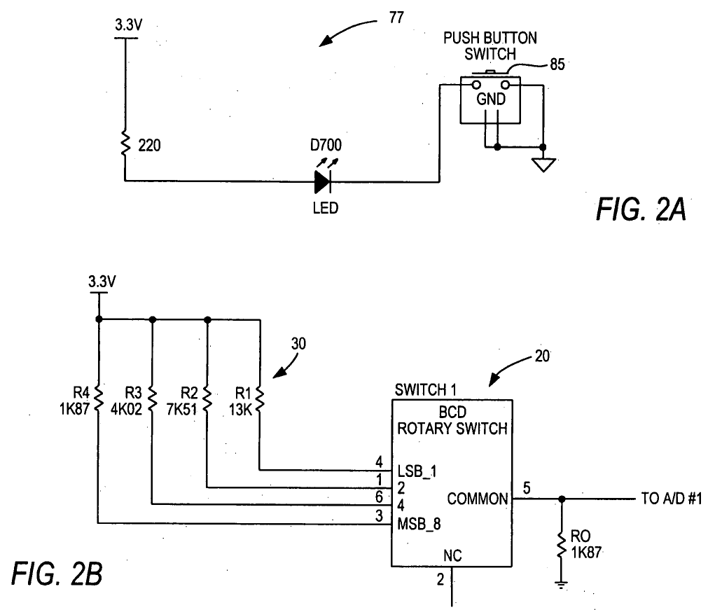

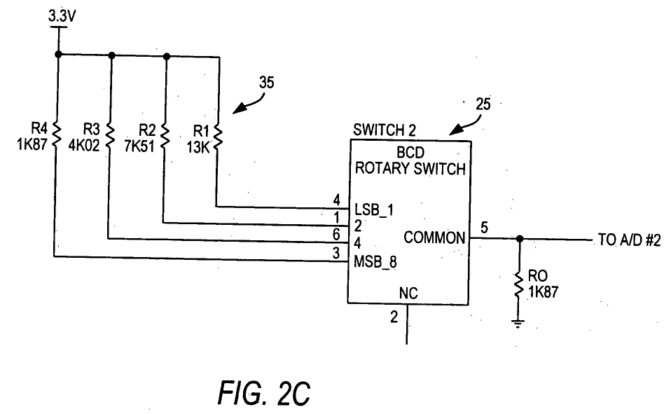

In operation, the radio receiver system 5 operates in the following manner. A user selects a two digit frequency channel assignment with the rotary switches 20, 25. The user then inserts the programming unit 15 in the programmer port of the receiver unit 10 and presses the push button switch 85 (FIG. 2A) located on the programmer 15. The assertion of the push-button switch 85 (FIG. 2A) generates an interrupt signal that causes the microcontroller 50 of the receiver unit 10 to read the values in each of the analog to digital converters 40, 45 and find the corresponding configuration word in a lookup table stored in the microprocessor 50. A person of ordinary skill in the relevant art will readily recognize that the push-button switch may be substituted with any momentary switch or other mechanism that is capable of generating the interrupt signal. The new frequency selection information is passed on to the receiver unit 10 and an light emitting diode (LED) 77 on the programming unit 15 lights up on the programmer indicating that the new values were passed on to the receiver unit 10.

Optionally, a BCD display LED could be integrated to provide positive feedback as to the frequency selected. The frequency selection process does not require power cycling and once the LED 77 lights up, the programming unit 15 can be taken out of the programmer port (not shown) on the receiver unit 10. The last selected frequency is stored on the receiver unit 10 and the user needs to reprogram the receiver unit 10 only if the receiver operation is desired on a different frequency.

The detachable programming unit 15 does not require a separate power supply as it receives power from the receiver unit 10, through the programming port, thereby simplifying its design. The system 5 also uses only one interface pin per rotary switch 20, 25 to send switch position information. Each of these lines 46, 47 are connected to one of the analog-to-digital converters 40, 45 respectively. It should be noted that the analog-to-digital converters 40, 45 can be either external or integrated within the microcontroller 50.

Referring to FIGS. 2A, 2B and 2C, a schematic diagram of the detachable programming unit 15 is shown. FIG. 2A shows a schematic diagram of the push button switch 85; FIG. 2B shows a schematic diagram of the rotary switch 20 and resistor network 30, and FIG. 2C shows a schematic diagram of the rotary switch 25 and resistor network 35.

Multi-Band Operation

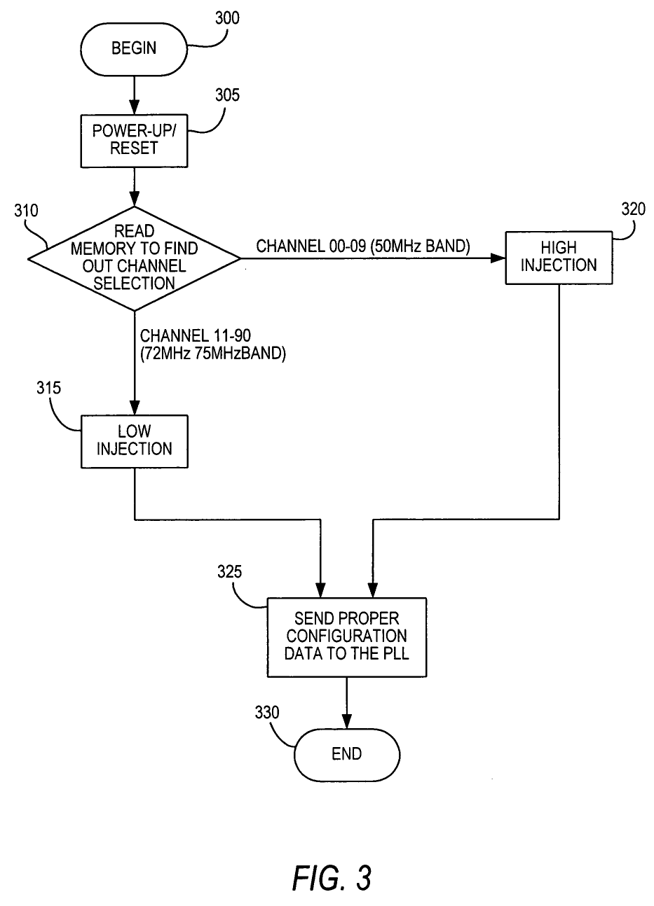

To achieve good sensitivity and performance the phase noise of the local oscillator signal on the receiver unit 10 must be minimized. In traditional designs, coverage of all of the North American radio controlled bands (50 Mhz, 72 Mhz, 75 Mhz) requires a wideband VCO/PLL setup; however, making the local oscillator wideband degrades the phase-noise performance and ultimately the performance of the receiver unit 10. To overcome this disadvantage, in one preferred embodiment of the present invention, a selective high/low local oscillator (LO) injection process, as shown in the flowchart of FIG. 3, is used.

Referring to FIG. 3, the selective high/low local oscillator (LO) injection process begins at step 300 and then proceeds to step 305 where the receiver unit 10 (FIG. 1) is powered-up or reset. The process then proceeds to step 310 where the memory of the microcontroller 50 (FIG. 1) is read to determine whether the user has selected a channel in the 50 MHz band or in the 72/75 MHz for programming the receiver unit 10 (FIG. 1). If the user has selected a channel in the 72/75 MHz band, the process proceeds to step to step 315 where a high injection process is utilized and then proceeds to step 325 where the proper configuration data for the LO is sent to the PLL. If the user has selected a channel in the 50 MHz band, the process proceeds to step 320 where a low injection process is utilized and then proceeds to step 325 where the proper configuration data for the LO is sent to the PLL. Once the proper configuration data has been sent to the PLL, the process proceeds to step 330 where it ends.

The selective high/low injection process keeps the LO frequency within a very narrow oscillation range while, at the same time, allowing a super-heterodyne operation to be performed on a much wider RF input. In this way, an ultra-narrow band receiver that can cover an RF frequency range that spans more than 25 Mhz may be implemented, while the local oscillator range of oscillation is kept in a range of less than 5 Mhz (between 61.31 Mhz-65.29 Mhz). The preferred embodiment of the present invention utilizes a narrow-band VCO and PLL with a nominal frequency of 60 Mhz. For 72/75 Mhz operation, a low injection of the LO results in 10.7 Mhz injection frequency (IF) (LO=F−10.7). Similarly for 50 Mhz operation, a high injection of the LO that also results in 10.7 Mhz IF (LO=RF+10.7). The two equations show the mathematical representation of the super-hetrodyning principle where a mixing process generates both the sum and differences of the two frequencies. For example, if one assumes an RF of 72.20 Mhz, for an IF frequency of 10.7 Mhz one must inject an LO of 61.5 Mhz: LO=RF−10.7 (low injection). For an RF of 50.80 Mhz and an IF of 10.7 Mhz, the same LO of 61.5 Mhz is required: LO=RF+10.7 (high injection). This unique selective LO injection process keeps the VCO around its nominal oscillating frequency and hence performing optimally. Firmware control intelligently detects the frequency band that the user has selected and based on this generate the proper LO for this frequency band.

Table 1 below shows a look up table for 72 Mhz frequencies typically used by hobbyists in radio controlled airplanes. Table 2 below shows a look up table for 75 Mhz frequencies typically used by hobbyists in radio controlled surface devices, e.g. cars, boats. Table 3 below shows a look up table for 50 Mhz frequencies typically used by hobbyists for other radio controlled devices.

TABLE 1
72 Mhz Airplane Frequencies

| Channel | RF Frequency (Mhz) | LO Frequency (Mhz) LOW Injection |
|---|---|---|
| 11 | 72.01 | 61.31 |
| 12 | 72.03 | 61.33 |
| 13 | 72.05 | 61.35 |
| 14 | 72.07 | 61.37 |
| 15 | 72.09 | 61.39 |
| 16 | 72.11 | 61.41 |
| 17 | 72.13 | 61.43 |
| 18 | 72.15 | 61.45 |
| 19 | 72.17 | 61.47 |
| 20 | 72.19 | 61.49 |
| 21 | 72.21 | 61.51 |
| 22 | 72.23 | 61.53 |
| 23 | 72.25 | 61.55 |
| 24 | 72.27 | 61.57 |
| 25 | 72.29 | 61.59 |
| 26 | 72.31 | 61.61 |
| 27 | 72.33 | 61.63 |
| 28 | 72.35 | 61.65 |
| 29 | 72.37 | 61.67 |
| 30 | 72.39 | 61.69 |
| 31 | 72.41 | 61.71 |
| 32 | 72.43 | 61.73 |
| 33 | 72.45 | 61.75 |
| 34 | 72.47 | 61.77 |
| 35 | 72.49 | 61.79 |
| 36 | 72.51 | 61.81 |
| 37 | 72.53 | 61.83 |
| 38 | 72.55 | 61.85 |
| 39 | 72.57 | 61.87 |
| 40 | 72.59 | 61.89 |
| 41 | 72.61 | 61.91 |
| 42 | 72.63 | 61.93 |
| 43 | 72.65 | 61.95 |
| 44 | 72.67 | 61.97 |
| 45 | 72.69 | 61.99 |
| 46 | 72.71 | 62.01 |
| 47 | 72.73 | 62.03 |
| 48 | 72.75 | 62.05 |
| 49 | 72.77 | 62.07 |
| 50 | 72.79 | 62.09 |
| 51 | 72.81 | 62.11 |
| 52 | 72.83 | 62.13 |
| 53 | 72.85 | 62.15 |
| 54 | 72.87 | 62.17 |
| 55 | 72.89 | 62.19 |
| 56 | 72.91 | 62.21 |
| 57 | 72.93 | 62.23 |
| 58 | 72.95 | 62.25 |
| 59 | 72.97 | 62.27 |
| 60 | 72.99 | 62.29 |

TABLE 2
75 Mhz surface (car/boat) Frequencies

| Channel | RF Frequency (Mhz) | LO Frequency (Mhz) LOW Injection |
|---|---|---|
| 61 | 75.41 | 64.71 |
| 62 | 75.43 | 64.73 |
| 63 | 75.45 | 64.75 |
| 64 | 75.47 | 64.77 |
| 65 | 75.49 | 64.79 |
| 66 | 75.51 | 64.81 |
| 67 | 75.53 | 64.83 |
| 68 | 75.55 | 64.85 |
| 69 | 75.57 | 64.87 |
| 70 | 75.59 | 64.89 |
| 71 | 75.61 | 64.91 |
| 72 | 75.63 | 64.93 |
| 73 | 75.65 | 64.95 |
| 74 | 75.67 | 64.97 |
| 75 | 75.69 | 64.99 |
| 76 | 75.71 | 65.01 |
| 77 | 75.73 | 65.03 |
| 78 | 75.75 | 65.05 |
| 79 | 75.77 | 65.07 |
| 80 | 75.79 | 65.09 |
| 81 | 75.81 | 65.11 |
| 82 | 75.83 | 65.13 |
| 83 | 75.85 | 65.15 |
| 84 | 75.87 | 65.17 |
| 85 | 75.89 | 65.19 |
| 86 | 75.91 | 65.21 |
| 87 | 75.93 | 65.23 |
| 88 | 75.95 | 65.25 |
| 89 | 75.97 | 65.27 |
| 90 | 75.99 | 65.29 |

TABLE 3
50 Mhz Licensed Frequencies

| Channel | RF Frequency (Mhz) | LO Frequency (Mhz) HIGH Injection |
|---|---|---|
| 00 | 50.8 | 61.5 |
| 01 | 50.82 | 61.52 |
| 02 | 50.84 | 61.54 |
| 03 | 50.86 | 61.56 |
| 04 | 50.88 | 61.58 |
| 05 | 50.9 | 61.6 |
| 06 | 50.92 | 61.62 |
| 07 | 50.94 | 61.64 |
| 08 | 50.96 | 61.6 |
| 09 | 50.98 | 61.68 |

Detachable Programmer Unit Resistor Value Computation and Optimization Routine

In the absence of resistor networks, at least four micro-controller pins per BCD rotary switch would be required in the programming unit 15 (FIG. 1). With two switches, the number of pins required increases to eight and this greatly diminishes the number of microcontroller 50 (FIG. 1) input/output pins available for other use. To overcome this disadvantage, a resistor network 30, 35 (FIG. 1) was developed that generates unique voltage outputs while maintaining a minimum voltage separation for comfortable operation with a wide variety of common analog-to-digital converters, whether discreet or integrated in modern microcontrollers.

The resistor network is computed in advance using an exhaustive iterative computer program written in C. The constraints of the program were selected such that the resulting resistor values are industry standard values for ease of manufacture and also the resultant voltage for a particular switch position offers sufficient voltage separation from the DC voltage values of the adjacent switch positions to ensure un-ambiguous detection of the user selected switch position.

The equations presented below and the accompanying constraints are just one example of different realizations of this methodology. An iterative methodology was coded as a computer program to compute the most efficient resistor values that are industry standard. The iterative program plugs in all possible resistor values from a set of industry standard values to derive the resulting solution set that fulfill the constraints.

Equations:
v1=(vcc*r0)/(r0+r1)
v2=(vcc*r0)/(r0+r2)
v3=(vcc*r0)/(((r1*r2)/(r1+r2))+r0)
v4=(vcc*r0)/(r0+r3)
v5=(vcc*r0)/(((r1*r3)/(r1+r3))+r0)
v6=(vcc*r0)/(x+r0)
v7=(vcc*r0)/((x*(r1/(x+r1)))+r0)
v8=(vcc*r0)/(r0+r4)
v9=(vcc*r0)/(((r1*r4)/(r1+r4))+r0)

Constraints:
v0=0
ycc=3.3 v
minimum voltage separation between two switch positions=110 mv
maximum voltage separation between two switch positions=500 mv

The 98 industry standard values used for the design of the radio receiver system of FIGS. 1 and 2A and 2B (all values in ohms) were:

1000, 1020, 1050, 1070, 1100, 1130, 1150, 1180, 1210, 1240, 1270, 1300, 1330, 1370, 1400, 1430, 1470, 1500, 1540, 1580, 1620, 1650, 1690, 1740, 1780, 1820, 1870, 1910, 1960, 2000, 2050, 2100, 2150, 2210, 2260, 2320, 2370, 2430, 2490, 2550, 2610, 2670, 2740, 2800, 2870, 2940, 3010, 3090, 3160, 3240, 3320, 3400, 3480, 3570, 3650, 3740, 3830, 3920, 4020, 4120, 4220, 4320, 4420, 4530, 4640, 4870, 4990, 5110, 5230, 5360, 5490, 5620, 5760, 5900, 6040, 6190, 6340, 6490, 6650, 6810, 6980, 7150, 7320, 7500, 7680, 8060, 8450, 8660, 8870, 9090, 9310, 9530, 9760, 10000, 13000, 33000

As presented in FIG. 2B, one of the solution sets derived is:

R0=1870 ohms

R1=13000 ohms

R2=7500 ohms

R3=4020 ohms

R4=1870 ohms

Those having ordinary skill in the relevant art will readily recognize that other suitable solutions sets that satisfy the particular constraints may be possible.

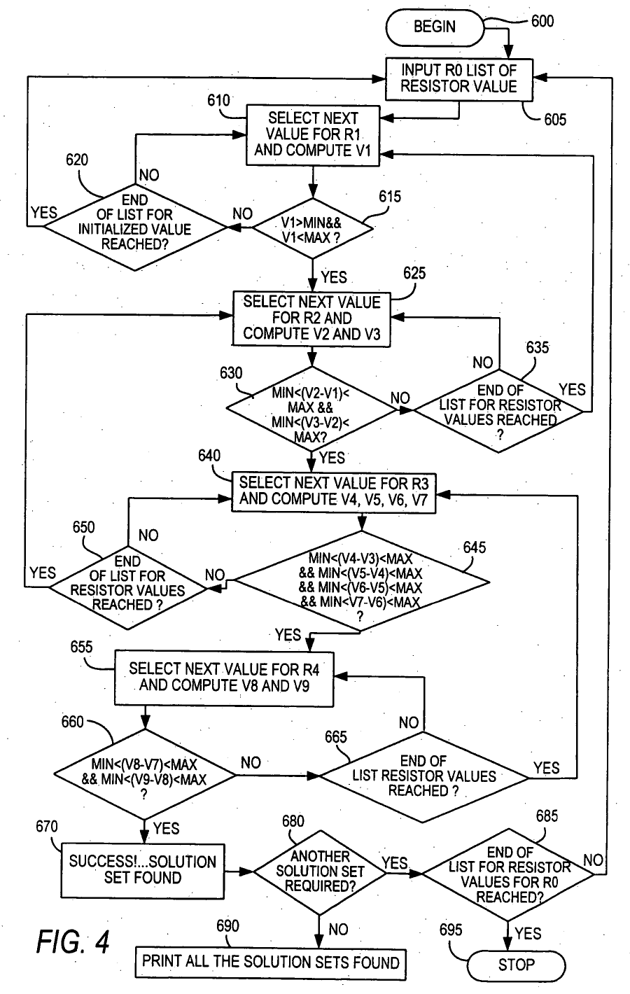

FIG. 4 shows a flow-chart of an iterative procedure for resistor optimization for the detachable programming unit 15 (FIG. 1). The iterative procedure for resistor optimization determines a solution to the equations listed above while keeping in consideration the constraints listed above. The procedure begins at step of 600 and then proceeds to step 605 where a value for resistor R0 is selected. The process then proceeds to step 610 where a resistor value for R1 is selected and a voltage V1 is computed. The process then proceeds to step 615 where the voltage V1 is tested against the constraints listed above. If V1 does not meet the constraints, the process proceeds to step 620 where the process determines whether the end of the list for resistor values has been reached. If yes, the resistor values RO and R1 are discarded the process returns to step 605 where another a value for resistor R0 is selected. If no, the resistor value R1 is discarded and the process proceeds to step 610.

If V1 meets the constraints listed above, the process proceeds to step 625 and a value for R2 is selected and voltages V2 and V3 are computed. The process then proceeds to step 630 where the constraints for V2 and V3 are checked. If the constraints are not met, the process proceeds to step 635 where it determines if the end of the list of resistor values has been reached. If yes, the resistor values R1 and R2 are discarded and the process returns to step 610. If no, the resistor value R2 is discarded and the process the returns to step 625. If the constraints are met, the process proceeds to step 640 where a value for R3 is selected and voltages V4, V5, V6, and V7 are computed. The process then proceeds to step 645 where the voltages V4, V5, V6, and V7 are tested to see if they meet the constraints listed above. If the constraints are not met, the process proceeds to step 650 where the it is determined whether the end of the list of resistor values has been reached. If yes, the resistor values R2 and R3 are discarded and the process returns to step 625. If no, the resistor value R3 is discarded and the process returns to step 640.

If the constraints are met, the process proceeds to step 655 where A value for R4 is selected and the voltages V8 and V9 are computed. The process then proceeds to step 660 where the constraints the voltages V8 and V9 listed above are checked. If the constraints are not met, the process proceeds to step 665 where the resistor value R4 is discarded and then the process proceeds to step 640, where a new value for R3 is selected and the voltages V4, V5, V6 and V7 are computed.

If the constraints are met, the iterative process proceeds to step 670 where a solution set is found. The process then proceeds to step 680 to determine if another solution set is required. If another solution set is required, the process proceeds to step 685 where it determines if the end of the list of resistor values for RO has been reach. If no, the process returns to step 605 and repeats. If yes, the process proceeds to step 695 where it stops.

At step 680, if no other solution set is required, the process proceeds to step 690 where the solution set that is computed is printed and then proceeds to step 695 where the process stops.

Multi-Protocol Detection

In another embodiment of the present invention, the radio receiver system 5 (FIG. 1) can detect all known encoding schemes, namely the analog positive shift pulse position modulation (PPM); analog negative shift PPM and digital pulse code modulation PCM protocols, utilized in the radio control hobby industry. While the different encoding schemes present different challenges; the techniques implemented in this embodiment of the present invention minimizes the component count and reduces the hardware complexity by shifting some of the tasks to firmware.

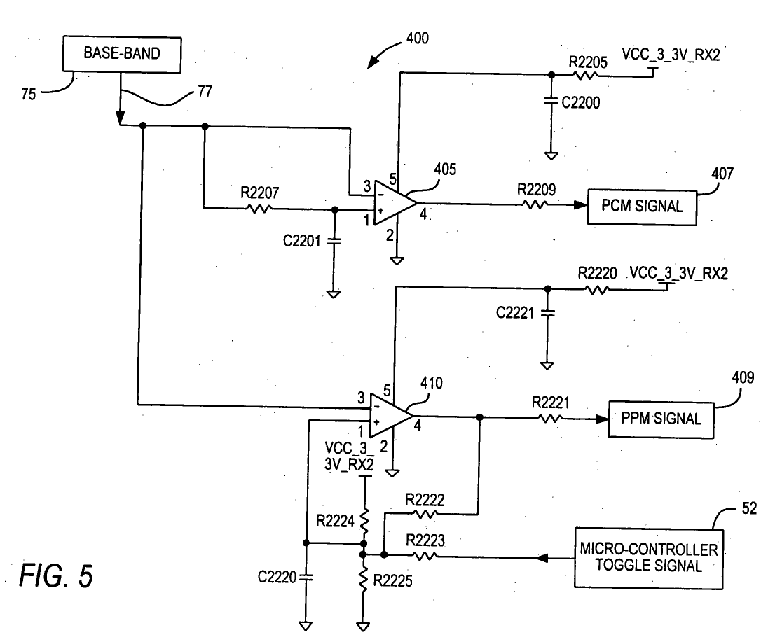

Referring to FIG. 5, a schematic diagram for a multi-protocol detection circuit 400 used in the radio receiver system 5 (FIG. 1) is shown. The multi-protocol detection circuit 400 includes a microcontroller 50 (FIG. 1) and two comparators 405, 410, which may be implemented either externally to or integrally with the microcontroller 50 (FIG. 1). The microcontroller 50 (FIG. 1), in conjunction with the two comparators 405, 410 is utilized to establish a complete PPM, plus positive and negative shift PPM signal detector. The use of the microcontroller 50 (FIG. 1) saves one additional comparator which would have to be used if a microcontroller with some intelligent processing was not used.

Each of the two comparators 405, 410 is fed by a base-band output 77 of the base-band recovery circuit 75. The first comparator 405 is a fixed threshold comparator is connected to the PCM input line 407 of the microcontroller 50, the second comparator 410 is for PPM signals and has a variable threshold to account for the two negative an d positive shift PPM signals. The output of the second comparator 410 is connected to the PPM input line 409 of the microcontroller 50 (FIG. 1). A voltage divider circuit is directly connected to microcontroller toggle pin 52. At boot-up of the receiver unit 15 (FIG. 1), the microcontroller 50 (FIG. 1) searches for a valid signal on line comparator 405 and comparator 410. Furthermore, the sub varieties of PPM signal are analyzed on 410 by the microcontroller toggle pin 52.

The microcontroller 50 (FIG. 1) at boot up senses the output of comparator 405 and determines if a valid signal is detected (generated by a transmitter (not shown) operating at the selected frequency). If a valid signal is not detected, the microcontroller 50 (FIG. 1) senses the output of comparator 410 with one voltage threshold, and if it does not detect anything, the microcontroller 50 (FIG. 1) toggles the threshold voltage of comparator 410 by means of the microcontroller toggle pin 52. If the microcontroller 50 (FIG. 1) still does not detect anything it goes back to sense comparator 405, and this process continues in an infinite loop until a valid signal is detected at either 405 or at 410 in one of the toggle modes.

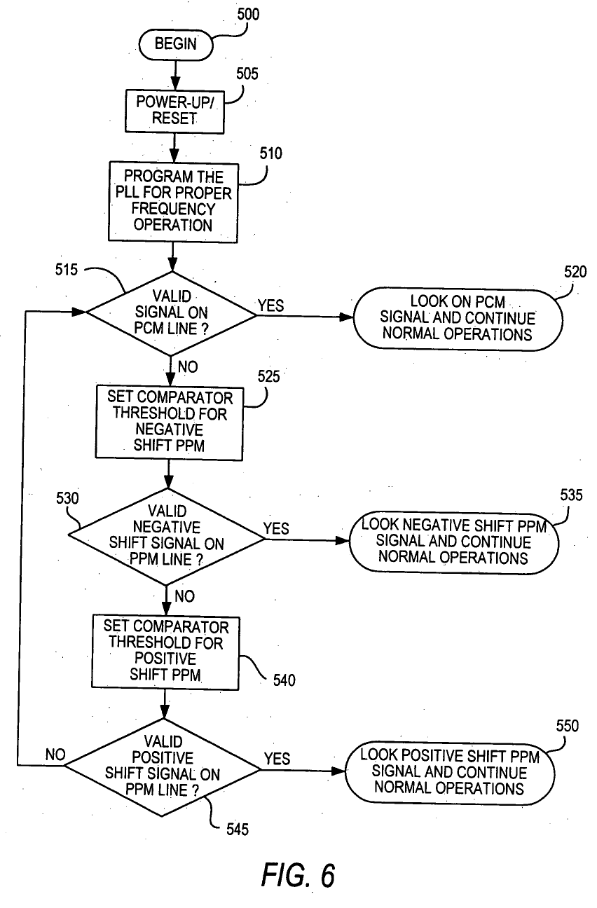

Referring to FIG. 6, a flow-chart of which illustrates the search method used by the microcontroller to detect the three different encoding protocols is shown. The method begins at step 500 and then proceeds to step 505 where the microcontroller 50 (FIG. 1) of the receiver unit 10 is powered-up and reset. The method then moves to step 510 where the microcontroller 50 (FIG. 1) programs the PLL circuit for proper frequency operation. The method then proceeds to decision step 515 where the method determines whether a valid signal is present on the PCM line. If a valid PCM signal is on the line, the method proceeds to step 520, where the microcontroller 50 (FIG. 1) locks on to the PCM signal and continues its normal operation. If a valid PCM is not on the line, the method proceeds to step 525 where the microcontroller sets the comparator threshold for negative shift PPM. The method then proceeds to step 530 where if determines whether a valid negative shift signal is on the PPM line. If it is, the method proceeds to step 535 where the microcontroller locks on the negative shift PPM signal and then continues its normal operation. If a valid negative shift signal is not on the PPM line, the method proceeds to step 540 where the microcontroller sets the comparator threshold for positive shift PPM. The method then proceeds to decision block 545 where it determines whether a valid positive shift signal is on the PPM line. If it is, the method proceeds to step 550 where the microcontroller locks on to the positive shift PPM signal and then continues its normal operation. If it is not, the method returns to step 515 and repeat the steps which follow again.

It should be noted that the above method is exemplary, it being understood that a person of ordinary skill in the relevant art may arrive at different comparator and resistor schemes that may achieve similar results.

A person of ordinary skill in the relevant art will readily recognize that a transmitter unit (not shown) for the multi-protocol radio-controlled receiver system 5 (FIG. 1) may be constructed in a similar manner as the receiver unit 10 (FIG. 1) to be programmed in like manner by the programming unit 15 (FIG. 1). Furthermore, a person of ordinary skill in the relevant art will readily recognize that the transmitter unit (not shown) may be integrated into the programming unit 15 (FIG. 1) of the present invention.

It should be understood that the preferred embodiments mentioned here are merely illustrative of the present invention. Numerous variations in design and use of the present invention may be contemplated in view of the following claims without straying from the intended scope and field of the invention herein disclosed.

Having thus described the invention, what is claimed as new and secured by Letters Patent is:

1. A multi-band radio control receiver system for a radio controlled device comprising:
a detachable programming unit for programming a radio frequency receiver unit with a desired operating frequency, the programming unit comprising:
a selector for selecting a value corresponding to the desired operating frequency for the receiver unit; and
a signaler for indicating availability of the selected value to the radio frequency receiver unit; and
the radio frequency receiver unit comprising:
a retriever for obtaining the selected value from the programming unit;
at least one analog-to-digital converter for converting the selected value from the selector into a digital signal;
a microcontroller operatively coupled to the at least one analog-to-digital converter for receiving the digital signal and for determining the desired operating frequency of the receiver unit therefrom;
a voltage controlled oscillator and a phase lock loop operatively coupled to the microcontroller for generating the desired operating frequency; and
an antenna for receiving radio controlled signals from a transmitting unit at the desired operating frequency.

2. A programming unit for a receiver unit of a radio controlled device, comprising:
a selector for selecting a value corresponding to a desired operating frequency for the receiver unit; and
a signaler for indicating availability of the selected value to the receiver unit for programming the receiver unit with the desired operating frequency.

3. The programming unit as defined in claim 2, wherein the selector comprises at least one switch.

4. The programming unit as defined in claim 2, wherein the selector comprises two switches.

5. The programming unit as defined in claim 3, wherein the at least one switch is a rotary switch.

6. The programming unit as defined in claim 3, wherein the at least one switch is a binary coded decimal switch.

7. The programming unit as defined in claim 3, wherein the selector further comprises at least one resistor network operatively coupled to the at least one switch for providing a minimum voltage separation between each position of the at least one switch.

8. The programming unit as defined in claim 3, wherein the selector further comprises at least one resistor network operatively coupled to the at least one switch for providing a maximum voltage separation between each position of the at least one switch.

9. The programming unit as defined in claim 7, wherein the at least one resistor network provides a minimum voltage separation of 110 mV between each position of the at least one switch.

10. The programming unit as defined in claim 8, wherein the at least one resistor network provides a maximum voltage separation of 500 mV between each position of the at least one switch.

11. The programming unit as defined in claim 7, wherein the resistor network comprises resistors having industry standard values.

12. The programming unit as defined in claim 8, wherein the resistor network comprises resistors having industry standard values.

13. The programming unit as defined in claim 2, wherein the signaler is a momentary switch.

14. The programming unit as defined in claim 2, wherein the signaler is an interrupt request.

15. A programmable receiver unit for a radio controlled device adapted to obtain a selected value from a programming unit, comprising:
a retriever for obtaining the selected value from the programming unit;
at least one analog-to-digital converter for converting the selected value into a digital signal;
a microcontroller operatively coupled to the at least one analog-to-digital converter for receiving the digital signal and for determining the desired operating frequency of the receiver unit therefrom;
a voltage controlled oscillator and a phase lock loop operatively coupled to the microcontroller for generating the desired operating frequency; and
an antenna for receiving radio controlled signals from a transmitting unit at the desired operating frequency.

16. The programmable receiver unit as defined in claim 15, wherein the receiver unit further comprises a multi-protocol detection circuit for detecting any of the protocols utilized in the radio controlled hobby industry.

17. The programmable receiver unit as defined in claim 16, wherein the protocols are selected from the group consisting of positive shift PPM, negative shift PPM and PCM.

18. The programmable receiver unit as defined in claim 15, wherein the microcontroller determines the desired operating frequency of the receiver unit using a look-up table.

19. The programmable receiver unit as defined in claim 18, wherein the look-up table is accessed using the selected value.

20. A programmable transmitter unit for a radio controlled device adapted to obtain a selected value from a programming unit, comprising:
a retriever for obtaining the selected value from the programming unit;
at least one analog-to-digital converter for converting the selected value into a digital signal;
a microcontroller operatively coupled to the at least one analog-to-digital converter for receiving the digital signal and for determining the desired operating frequency of the receiver unit therefrom;
a voltage controlled oscillator and a phase lock loop operatively coupled to the microcontroller for generating the desired operating frequency; and
an antenna for transmitting radio controlled signals to a receiver unit at the desired operating frequency.
